(19) United States
(12) Patent Application Publication
(10) Pub. No.: US 2026/0185433 A1
(43) Pub. Date: Jul. 2, 2026

(54) METHODS FOR DETECTION AND MITIGATION OF WELL SCREEN OUT

(71) Applicant: BJ Energy Solutions, LLC, The Woodlands, TX (US)

(72) Inventors: Tony YEUNG, The Woodlands, TX (US); Ricardo RODRIGUEZ-RAMON, The Woodlands, TX (US); Joseph FOSTER, The Woodlands, TX (US)

(73) Assignee: BJ Energy Solutions, LLC, The Woodlands, TX (US)

(21) Appl. No.: 19/268,801

(22) Filed: Jul. 14, 2025

Related U.S. Application Data
(63) Continuation of application No. 18/583,167, filed on Feb. 21, 2024, now Pat. No. 12,385,379.
Application No. 18/583,167 is a continuation of application No. 17/991,007, filed on Nov. 21, 2022, now Pat. No. 11,939,854.
Application No. 17/991,007 is a continuation of application No. 17/355,920, filed on Jun. 23, 2021, now Pat. No. 11,566,506.
Application No. 17/355,920 is a continuation of application No. 17/303,841, filed on Jun. 9, 2021, now Pat. No. 11,208,881.
Application No. 17/303,841 is a continuation of application No. 17/182,408, filed on Feb. 23, 2021, now Pat. No. 11,066,915.
(60) Provisional application No. 62/705,050, filed on Jun. 9, 2020.

(51) Int. Cl. E21B 43/267; E21B 21/08; E21B 43/12; E21B 43/26; G08B 21/18

(52) U.S. Cl. CPC E21B 43/267; E21B 21/08; E21B 43/12; E21B 43/26; E21B 43/2607; G08B 21/182

(57) ABSTRACT

Methods, systems, and controllers for detecting and mitigating well screen outs may include a controller configured to operate a fracturing pump to supply fluid at a discharge rate to a wellhead at a fracturing well site. The controller may also operate a blender positioned to deliver a blend of proppant and fluid to the fracturing pump. The controller may compare a fluid pressure increase rate to a preselected increase rate indicative of a potential well screen out. The controller may incrementally decrease the discharge rate of the fracturing pump and a flow rate of a blender when the fluid pressure increase rate of the wellhead exceeds the preselected increase rate and the fluid pressure is within a preselected percentage of a maximum wellhead pressure until the fluid pressure of the fluid supplied to the wellhead is stabilized.

### PRIORITY CLAIM

This is application is a continuation of U.S. Non-Provisional application Ser. No. 18/583,167, filed Feb. 21, 2024, titled “METHODS FOR DETECTION AND MITIGATION OF WELL SCREEN OUT,” which is a continuation of U.S. Non-Provisional application Ser. No. 17/991,007, filed Nov. 21, 2022, titled “METHODS FOR DETECTION AND MITIGATION OF WELL SCREEN OUT,” now U.S. Pat. No. 11,939,854 issued Mar. 26, 2024, which is a continuation of U.S. Non-Provisional application Ser. No. 17/355,920, filed Jun. 23, 2021, titled “METHODS FOR DETECTION AND MITIGATION OF WELL SCREEN OUT,” now U.S. Pat. No. 11,566,506 issued Jan. 31, 2023, which is continuation of U.S. Non-Provisional application Ser. No. 17/303,841, filed Jun. 9, 2021, titled “METHODS AND SYSTEMS FOR DETECTION AND MITIGATION OF WELL SCREEN OUT,” now U.S. Pat. No. 11,208,881, issued Dec. 28, 2021, which is a continuation of U.S. Non-Provisional application Ser. No. 17/182,408, filed Feb. 23, 2021, titled “METHODS FOR DETECTION AND MITIGATION OF WELL SCREEN OUT,” now U.S. Pat. No. 11,066,915, issued Jul. 20, 2021, which claims priority to and the benefit of U.S. Provisional Application No. 62/705,050, filed Jun. 9, 2020, titled “METHODS AND SYSTEMS FOR DETECTION AND MITIGATION OF WELL SCREEN OUT,” the disclosures of which are incorporated herein by reference in their entireties.

### TECHNICAL FIELD

The application generally relates to mobile power units and, more specifically, drive equipment and methods for usage, installation on, and controls for mobile fracturing transportation platforms.

### BACKGROUND

Hydrocarbon exploration and energy industries employ various systems and operations to accomplish activities including drilling, formation evaluation, stimulation and production. Measurements such as temperature, pressure, and flow measurements are typically performed to monitor and assess such operations. During such operations, problems or situations may arise that may have a detrimental effect on the operation, equipment, and/or safety of operators. For example, during a stimulation or fracturing operation, screen out conditions may occur, which may cause rapid pressure increases that may compromise the operation and/or damage equipment.

### SUMMARY

Embodiment of systems, methods, and controllers that control the operation to detect and mitigate screen outs such that screen outs are avoided, for example, may save time, may increase awareness of conditions within the well, and may increase safety at a wellsite hydraulic fracturing pumper system. For example, Applicant has recognized that a controller detecting and mitigating screen outs may avoid packing of a well and avoid the need for additional operations to stimulate a well, e.g., wire line operations. In addition, a controller that avoids rapid pressure increases associated with screen outs may reduce stress on fracturing equipment including power end assemblies, shocking of prime movers and gearing systems associated therewith, and piping of the well. Further, the methods and systems detailed herein may prevent energy release in the form of release pressure through a pressure relief valve, e.g., a wellhead or manifold pressure relief valve. Avoiding pressure release from a pressure valve may also increase the safety of the wellhead, for example, by not over pressuring a wellhead.

Applicant also has recognized that a controller that detects and mitigates screen outs may also increase awareness of conditions within the well by detecting a rate of pressure increase more accurately and at a more frequent rate than with manual control. In some embodiments, the controller may prewarn by one or more tiers of pressure increase rates such that an operator may manually adjust proppant concentration or take other measures to avoid screen outs before the controller intervenes as would be appreciated by those skilled in the art. The controller may also control the blender and the fracturing pump with a single command such that an operator is not required to sequence both elements in a safe manner to avoid damage to equipment, e.g., via cavitation, and to avoid screen out.

In accordance with an embodiment of the present disclosure, a method of detecting and mitigating well screen out at a fracturing well site during hydrocarbon production may include operating a fracturing pump to supply fluid at a discharge rate to a wellhead at a fracturing well site. The method also may include operating a blender positioned to deliver a blend of proppant and fluid to the fracturing pump. A fluid pressure of the fluid supplied to the wellhead may be measured and a fluid pressure increase rate of the fluid may be determined from the fluid pressure. The fluid pressure increase rate may be compared to a preselected increase rate indicative of a potential well screen out. When the fluid pressure increase rate exceeds the preselected increase rate and the fluid pressure is within a preselected percentage of a maximum wellhead pressure of the well head, the discharge rate of the fracturing pumps may be incrementally decreased until the fluid pressure increase rate is stabilized. Stabilizing the fluid pressure increase rate may include the fluid pressure increase rate being equal to or less than zero.

In accordance with another embodiment of the present disclosure, a wellsite hydraulic fracturing pumper system may include one or more fracturing pumps, a blender, a pressure transducer, and a controller. The one or more fracturing pumps may be configured to provide fluid to a wellhead when positioned a hydrocarbon well site. The blender may be configured to provide fluid and proppant to the one or more fracturing pumps. The pressure transducer may be positioned adjacent an output of the one or more fracturing pumps or at the wellhead. The pressure transducer may be configured to measure a fluid pressure of the fluid provided to the wellhead. The controller may control the one or more fracturing pumps and the blender. The controller may be positioned in signal communication with the pressure transducer such that the controller receives the fluid pressure of the fluid provided to the wellhead. The controller may include memory, a processor to process data, and a screen out detection and mitigation protocol program stored in the memory and responsive to the process and in which the protocol of the controller may incrementally decrease a discharge rate of the one or more fracturing pumps and a flow rate of the blender in response to a fluid pressure increase rate of the fluid suppled to the wellhead being greater than a preselected increase rate and the fluid pressure of the fluid provided to the wellhead being greater than a preselected percentage of a maximum wellhead pressure until the fluid pressure is stabilized.

In yet another embodiment of the present disclosure, a controller for a hydraulic fracturing pumper system may include a pressure input, a first control output, and a second control output. The pressure input may be in signal communication with a pressure transducer that measures a fluid pressure of a fluid being provided to a wellhead. The first control output may be in signal communication with a fracturing pump such that the controller provides pump control signals to the fracturing pump to control a discharge rate of the fracturing pump. The second control output may be in signal communication with a blender such that the controller provides blender control signals to the blender to control a flow rate of the blender and delivery of a proppant from the blender. The controller may be configured to calculate a fluid pressure increase rate of the fluid pressure, compare the fluid pressure increase rate of the fluid pressure to a preselected increase rate, and incrementally decrease a discharge rate of the fracturing pump and a flow rate of the blender when the fluid pressure increase rate is greater than the preselected increase rate and the fluid pressure is within a preselected percentage of a maximum wellhead pressure of the wellhead until the fluid pressure of the fluid is supplied to the wellhead is stabilized.

Those skilled in the art will appreciate the benefits of various additional embodiments reading the following detailed description of the embodiments with reference to the below-listed drawing figures. It is within the scope of the present disclosure that the above-discussed embodiments and aspects be provided both individually and in various combinations.

### BRIEF DESCRIPTION OF THE DRAWINGS

The accompanying drawings, which are included to provide a further understanding of the embodiments of the present disclosure, are incorporated in and constitute a part of this specification, and together with the detailed description, serve to explain the principles of the embodiments discussed herein. The present disclosure may be more readily described with reference to the accompanying drawings.

FIG. 1 is a schematic view of a wellsite hydraulic fracturing pumper system according to an embodiment of the disclosure.

FIG. 2 is a schematic view of a control system of the wellsite hydraulic fracturing pumper system of FIG. 1.

FIG. 3 is a flowchart of a method of detecting and mitigating a well screen out of a well according to an embodiment of the present disclosure.

Corresponding parts are designated by corresponding reference numbers throughout the drawings.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect may be combined with features from any other embodiment or aspect in any appropriate combination. For example, any individual or collective features of method aspects or embodiments may be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

Embodiments of the present disclosure are directed to methods and systems for detecting and mitigating well screen outs during the operations of wellsite hydraulic fracturing pumping systems during the production of hydrocarbons. The methods and systems detailed herein may be executed on a controller that provides alerts or alarms to an operator of a potential well screen out and may intervene to prevent the fluid pressure provided to the well from exceeding a maximum well pressure.

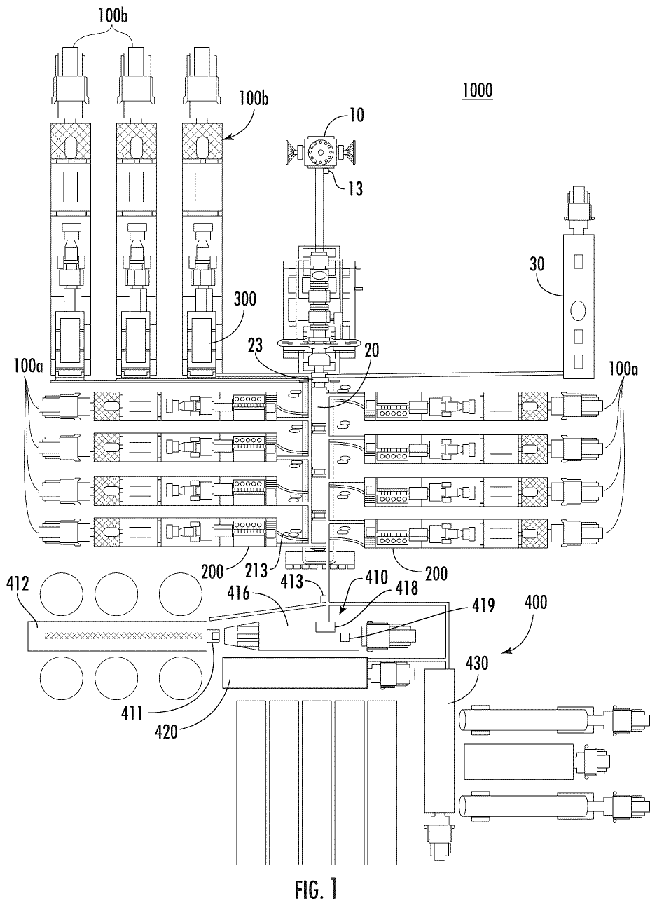

FIG. 1 illustrates an exemplary wellsite hydraulic fracturing pumper system 1000 that is provided in accordance with an embodiment of the present disclosure. The wellsite hydraulic fracturing pumper system 1000 includes a plurality of mobile power units 100 arranged around a wellhead 10 to supply the wellhead 10 with high-pressure fracturing fluids and recover oil and/or gas from the wellhead 10 as will be understood by those skilled in the art. As shown, some of the mobile power units 100, e.g., mobile power units 100a, drive a hydraulic fracturing pump 200 that discharges high pressure fluid to a manifold 20 such that the high pressure fluid is provided to the wellhead 10. Additionally, some of the mobile power units 100, e.g., mobile power units 100b, drive an electrical generator 300 that provides electrical power to the wellsite hydraulic fracturing pumper system 1000.

The wellsite hydraulic fracturing pumper system 1000 also includes a blender unit 410, a hydration unit 420, or a chemical additive unit 430 which may be referred to generally as backside equipment 400. Specifically, the blender unit 410 provides a flow of fluid to the fracturing pumps 200 which is pressurized by and discharged from the fracturing pumps 200 into the manifold 20. The blender unit 410 may include one or more screw conveyors 412 that provides proppant to a mixer 416 of the blender unit 410. The blender unit 410 also includes a discharge pump 418 that draws fluid from the mixer 416 such that a flow of fluid is provided from the blender unit 410 to the fracturing pumps 200. The fluid from the mixer 416 may include proppant provided by the screw conveyors 412 and/or chemicals for the fluid of the fracturing pumps 200. When blender unit 410 provides proppant to the fracturing pumps 200, the proppant is in a slurry which may be considered a fluid as will be understood by those skilled in the art.

The wellsite hydraulic fracturing pumper system 1000 includes a supervisory control unit that monitors and controls operation of the mobile power units 100a driving the fracturing pumps 200, the mobile power units 100b driving electrical generators 300, and the units 410, 420, 430 and may be referred to generally as controller 30. The controller 30 may be a mobile control unit in the form of a trailer or a van, as appreciated by those skilled in the art. As used herein, the term “fracturing pump” may be used to refer to one or more of the hydraulic fracturing pumps 200 of the hydraulic fracturing pumper system 1000. In some embodiments, all of the hydraulic fracturing pumps 200 are controlled by the controller 30 such that to an operator of the controller 30, the hydraulic fracturing pumps 200 are controlled as a single pump or pumping system.

The controller 30 is in signal communication with the blender unit 410 to control the delivery of the proppant to the mixer 416 and a flow rate of fluid from the discharge pump 418 to the fracturing pumps 200. The controller 30 is also in signal communication with the fracturing pumps 200 to control a discharge rate of fluid from the fracturing pumps 200 into the manifold 20. In addition, the controller 30 is in signal communication with one or more sensors of the wellsite hydraulic fracturing pumper system 1000 to receive measurements or data with respect to the fracturing operation. For example, the controller 30 receives a measurement of pressure of the fluid being delivered to the wellhead 10 from a wellhead pressure transducer 13, a manifold pressure transducer 23, or a pump output pressure transducer 213. The wellhead pressure transducer 13 is disposed at the wellhead 10 to measure a pressure of the fluid at the wellhead 10. The manifold pressure transducer 23 is shown at an end of the manifold 20. However, as understood by those skilled in the art, the pressure within the manifold 20 is substantially the same throughout the entire manifold 20 such that the manifold pressure transducer 23 may be disposed anywhere within the manifold 20 to provide a pressure of the fluid being delivered to the wellhead 10. The pump output pressure transducer 213 is disposed adjacent an output of one of the fracturing pumps 200 which is in fluid communication with the manifold 20 and thus, the fluid at the output of the fracturing pumps 200 is at substantially the same pressure as the fluid in the manifold 20 and the fluid being provided to the wellhead 10. Each of the fracturing pumps 200 may include a pump output pressure transducer 213 and the controller 30 may calculate the fluid pressure provided to the wellhead 10 as an average of the fluid pressure measured by each of the pump output pressure transducers 213.

The controller 30 is also in signal communication with sensors disposed about the blender unit 410. For example, the blender unit 410 may include a blender screw encoder/pickup 411 that provides a rotation rate of the screw conveyors 412 of the blender unit 410 which provide proppant to the mixer 416 such that proppant is provided to the fracturing pumps 200. When the screw conveyors 412 are not active or rotating, proppant is not being added to the mixer 416 such that no proppant is being provided to the fracturing pumps 200. The blender unit 410 may include a blender flow meter 413 that measures a flow of fluid from the blender unit 410 to the fracturing pumps 200.

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another. For example, a pump output pressure transducer 213 may be in direct electrical communication with a pump controller (not explicitly shown) and the pump controller may be in direct electrical communication or wireless communication with a master controller (not explicitly shown) of the mobile power unit 100 which is in electrical or wireless communication with the controller 30.

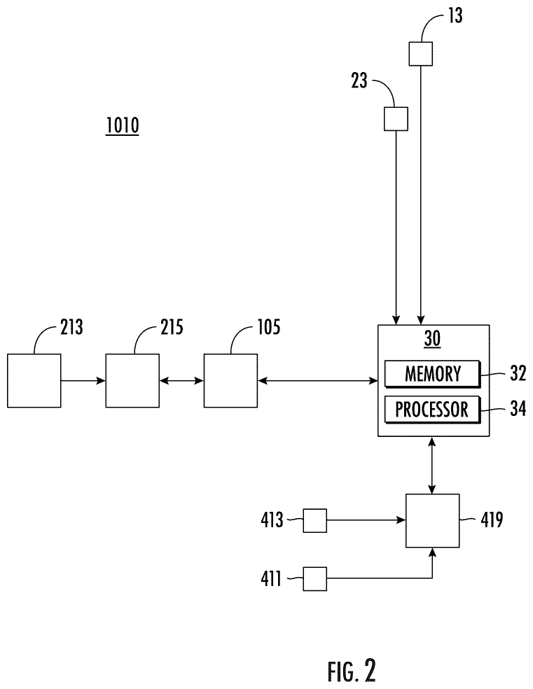

FIG. 2 illustrates a schematic of a control system for the wellsite hydraulic fracturing pumper system 1000 referred to generally as a control system 1010. The control system 1010 includes the controller 30 that is in signal communication with the wellhead pressure transducer 13, a manifold pressure transducer 23, and a pump output transducer 213. The controller 30 includes memory 32 and a processor 34. The memory 32 may be loaded or preloaded with programs, e.g., detection and mitigation protocol programs as detailed below, that are executed on the processor 34. The pump output transducer 213 may be in direct signal or electrical communication with a pump controller 215 which may be in direct signal or electrical communication with a mobile power unit controller 105 with the mobile power unit controller 105 in direct signal or electrical communication with the controller 30 such that the pump output transducer 213 is in signal communication with the controller 30. In some embodiments, the pump output transducer is in direct signal communication with the controller 30. The pump controller 215 is configured to control the fracturing pump 200 in response to commands signals provided by the controller 30 or the mobile power unit controller 30. The pump controller 215 may include a pump profiler that records events experienced by the fracturing pump 200. The recorded events may be used to schedule maintenance of the fracturing pump 200.

The control system 1010 may include a blender controller 419, a blender flow meter 413, and a blender screw encoder/pickup 411. The blender flow meter 413 and the blender screw encoder/pickup 411 may be in direct signal or electrical communication with the blender controller 419 which may be in direct signal or electrical communication with the controller 30 such that the blender flow meter 413 and the blender screw encoder/pickup 411 are in signal communication with the controller 30.

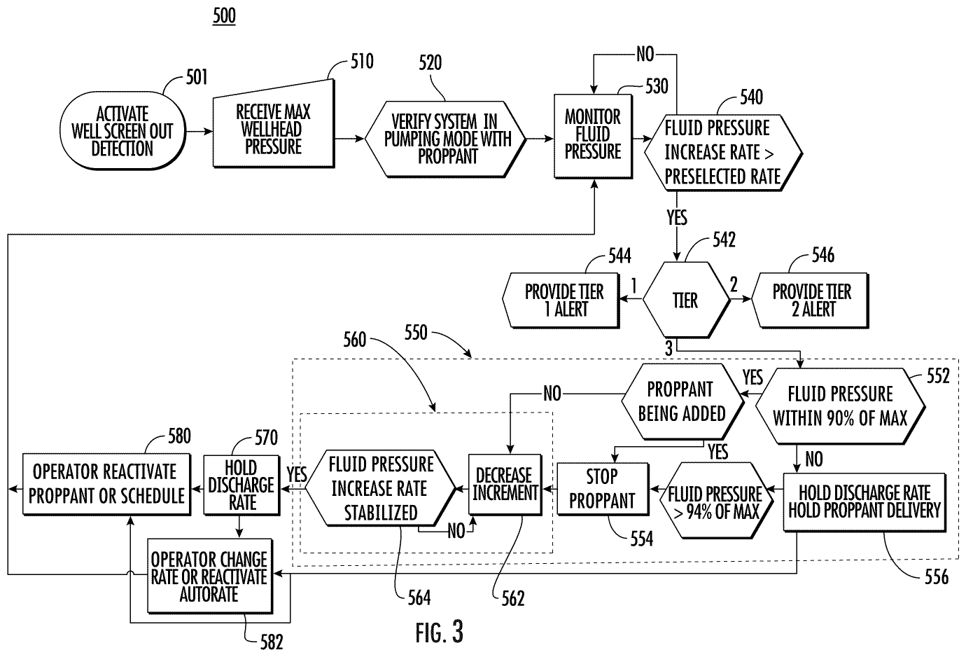

FIG. 3 illustrates a method of detecting and mitigating well screen out for a hydraulic fracturing operation is described in accordance with embodiments of the present disclosure and is referred to generally as method 500. The method 500 is detailed with reference to the wellsite hydraulic fracturing pumper system 1000 and the control system 1010 of FIGS. 1 and 2. Unless otherwise specified, the actions of the method 500 may be completed within the controller 30. Specifically, the method 500 may be included in one or more programs or protocols loaded into the memory 32 of the controller 30 and executed on the processor 34. The well screen out protocol is activated (Step 501) either automatically when the controller 30 is started or may be manually activated by an operator. When well screen out protocol is activated, a maximum wellhead pressure is provided to the controller 30 (Step 510). The maximum wellhead pressure may be input by an operator into a human interface of the controller 30 or may be a preselected pressure programmed into the controller 30. When the maximum wellhead pressure is provided by an operator, the controller may verify that the inputted maximum wellhead pressure is within a preselected range. If the inputted maximum wellhead pressure is outside of the preselected range, the controller 30 may display an alarm or reject the inputted maximum wellhead pressure and request another value be inputted by the operator and verify the new inputted maximum wellhead pressure until the inputted maximum wellhead pressure is within the preselected range. The preselected range may be in a range of up to 15,000 per square inch (psi), for example, as will be understood by those skilled in the art.

With the maximum wellhead pressure, the controller 30 verifies that the wellsite hydraulic fracturing pumper system 1000 is in a pumping mode in which at least one of the fracturing pumps 200 is active and that the blender unit 410 is adding proppant to the fluid provided to the fracturing pumps 200 (Step 520). The controller 30 may verify the blender unit 410 is adding proppant from verifying that one or more of the screw conveyors 412 is rotating via the blender screw encoder/pickups 411. If either the wellsite hydraulic fracturing pumper system 1000 is not in a pumping mode or that the blender unit 410 is not adding proppant to the fluid being supplied to the fracturing pumps 200 the method 500 is terminated or deactivated. The method 500 may be reactivated manually or when the fracturing pumps 200 and the blender unit 410 are activated to provide fluid including proppant to the wellhead 10.

Continuing to refer to FIG. 3, when the fracturing pumps 200 and the blender unit 410 are activated to provide fluid including proppant to the wellhead 10, the controller 30 monitors a fluid pressure of fluid being provided to the wellhead 10 to detect a potential screen out within the well (Step 530). The fluid pressure of the fluid provided to the wellhead 10 may be monitored from the wellhead pressure transducer 13, the manifold pressure transducer 23, the pump output pressure transducers 213, or combinations thereof. To detect for a potential screen out within the well, the controller 30 monitors a rate of increase of the fluid pressure of fluid being provided to the wellhead 10 which is referred to as fluid pressure increase rate. The fluid pressure increase rate may be calculated by comparing the fluid pressure at a first time P(t1) and fluid pressure at a second time P(t2) such that the fluid pressure increase rate is calculated as:

$$Fluid Pressure Increase Rate = \frac{Δ P}{Δ t} = \frac{P ( {t}_{2} ) - P ( {t}_{1} )}{{t}_{2} - {t}_{1}} .$$

The fluid pressure may be sampled at a rate in a range of 1 Hertz (Hz) to 300 Hz and the fluid pressure increase rate may be smoothed by taking an average of 2 samples to 100 samples to prevent a single spike of a sample or an erroneous sample from triggering the detection of a potential screen out.

The calculated fluid pressure increase rate is compared to a preselected increase rate to determine if there is a potential for screen out within the well (Step 540). The preselected increase rate may be an increase rate that is entered by an operator or may be preprogrammed into the controller 30. The preselected increase rate may be based on historical data of well screen out from other wells, for example, or specific to the well being monitored, as will be understood by those skilled in the art. When the fluid pressure increase rate is below the preselected increase rate, the controller 30 continues to monitor the fluid pressure increase rate while proppant is being added to the fluid provided to the fracturing pumps 200.

When the fluid pressure increase rate meets or exceeds the preselected increase rate, a tier of the fluid pressure increase rate may be determined (Step 542). For example, when the fluid pressure increase rate is in a first range of 600 psi/s to 800 psi/s such that the fluid pressure increase rate is a Tier 1 Potential Screen Out and the potential for screen out may be minor. When the fluid pressure increase rate is a Tier 1 Potential Screen Out, the controller 30 provides an alert or message to an operator that the fluid pressure increase rate is high or there is a potential for screen out (Step 544). The message or alert may be a warning light, a message on a screen, an audible alert, or combinations thereof. In response to the alert or message, an operator may take no action, reduce or stop the addition of proppant to the fluid provided to the fracturing pumps 200, or reduce a discharge rate of the fracturing pumps 200.

Continuing with the example, when the fluid pressure increase rate is in a second range of 800 psi/s to 1200 psi/s such that the fluid pressure increase rate is a Tier 2 Potential Screen Out and the potential for screen out is high. When the fluid pressure increase rate is a Tier 2 Potential Screen Out, the controller 30 provides an alarm or message to an operator that the fluid pressure increase rate is high or potential screen out is high (Step 546). The message or alarm may be a warning light, a message on a screen, an audible alert, or combinations thereof and is escalated from the message or alert provided for a Tier 1 Potential Screen Out. In response to the alarm or message, an operator may take no action, reduce or stop the addition of proppant to the fluid provided to the fracturing pumps 200, or reduce a discharge rate of the fracturing pumps 200.

When the fluid pressure increase rate is above the second range, e.g., 1200 psi/s, the potential for screen out is extremely high such that the fluid pressure increase rate is a Tier 3 Potential Screen Out and a screen out is likely. When the fluid pressure increase rate is a Tier 3 Potential Screen Out, a screen out is likely and the controller 30 enters an intervention or mitigation mode to prevent screen out and prevent or reduce damage to the well and the wellsite hydraulic fracturing pumper system 1000 by the mitigation process 550. When the controller 30 begins the mitigation process 550, the controller 30 provides an alert or message to an operator that the mitigation process 550 is running. The message or alert may be a warning light, a message on a screen, an audible alert, or combinations thereof and is escalated from the message or alert provided for a Tier 2 Potential Screen Out.

In the mitigation mode, the controller 30 compares the fluid pressure to the maximum wellhead pressure (Step 552). When the fluid pressure is greater than a first preselected percentage of the maximum wellhead pressure, e.g., 90%, the controller 30 verifies that the blender screw conveyors 412 are not providing proppant to the blender unit 410, e.g., that the blender screw conveyors 412 are not rotating. If the blender screw conveyors 412 are providing proppant to the blender unit 410, the controller 30 stops the blender screw conveyors 412 to stop delivery of proppant (Step 554). When the delivery of proppant is stopped or verified to be stopped, the controller 30 begins to incrementally decrease a discharge rate of the fracturing pumps 200 as defined by process 560.

The process 560 may include multiple iterations of decreases in a discharge rate of the fracturing pumps 200 by a preselected increment (Step 562) and determining the fluid pressure increase rate (Step 564). The process 560 continues to iterate through Steps 562 and 564 until the fluid pressure increase rate is no longer increasing or stabilized, e.g., less than or equal to zero. The preselected increment may be in a range of 0.5 barrels per minute (BPM) to 10 BPM, e.g., 2 BPM. In some embodiments, the preselected increment is less than 5 BPM. The process 560 may include decreasing the discharge rate of the fracturing pumps 200 by the preselected increment (Step 562) and delaying the determining the fluid pressure increase rate (Step 564) for a period of time or a number of cycles of the fracturing pump 200, e.g., 1 second or 25 cycles or revolutions of the fracturing pump 200. The delay in determining the fluid pressure increase rate may allow for the fluid pressure to react to the decreased discharge rate before the fluid pressure increase rate is determined. During each iteration of the process 560, the controller 30 may sequence the flow rate of the blender unit 410 and the discharge rate of the fracturing pump 200. Specifically, the controller 30 may first send a control signal to the fracturing pump 200 to decrease a discharge rate of the fracturing pump 200 by the increment and then send a control signal to the blender unit 410, e.g., the discharge pump 418 of the blender unit 410, to decrease a flow rate of fluid to the fracturing pump 200. By sequencing the blender unit 410 and the fracturing pumps 200 cavitation at the fracturing pumps 200 may be avoided. In addition, by the controller 30 sequencing the blender unit 410 and the fracturing pumps 200, the need for an operator to manually sequence the blender unit 410 and the fracturing pumps 200 to maintain a safe operation state is removed.

When the fluid pressure increase rate is stabilized such that the fluid pressure is not increasing or is decreasing (e.g., equal to or less than zero), the controller 30 terminates the mitigation process 550 and maintains the discharge rate of the fracturing pumps 200 (Step 570). When the mitigation process 550 is completed, an operator may begin providing proppant to in the fluid provided to the fracturing pumps 200 by activating the blender screw conveyors 412 (Step 580) and/or may manually change the discharge rate of the fracturing pumps 200 (Step 582). When the operator takes control at Steps 580, 582, the operator may reactivate an automatic or scheduled program of the operation the controller 30 returns to monitoring the fluid pressure increase rate of Step 530.

Returning back to the entry into the mitigation process 550, when the fluid pressure increase rate is a Tier 3 Potential Screen Out and the fluid pressure is below or less than the first preselected percentage of the maximum fluid pressure, e.g., 90%, the controller 30 maintains the discharge rate of the fracturing pumps 200 and the delivery of the proppant (Step 556). When the discharge rate of the fracturing pumps 200 and the delivery of the proppant is maintained, an operator may provide input to the controller 30 to manually change the discharge rate of the fracturing pumps 200 or reactivate an automatic or scheduled program to the operation of the controller 30 (Step 582). If an operator does not intervene, the controller 30 continues to monitor fluid pressure.

If the operator does not intervene and the fluid pressure reaches a second preselected percentage of the maximum fluid pressure, e.g., 94%, the controller 30 intervenes by preparing for and running the process 560. Specifically, the controller 30 prepares for the process 560 by stopping the blender screw conveyors 412 to stop delivery of proppant (Step 554). When the delivery of proppant is stopped, the controller 30 begins the process 560 to incrementally decrease a discharge rate of the fracturing pumps 200 as detailed above until by cycling through Step 562 and Step 564 until the fluid pressure increase rate is no longer increasing or stabilized, e.g., less than or equal to zero. When the fluid pressure increase rate is stabilized, the discharge rate of the fracturing pumps 200 is maintained (Step 570) such that the mitigation process 550 is complete or terminated. When the mitigation process 550 is completed, an operator may begin providing proppant to in the fluid provided to the fracturing pumps 200 by activating the blender screw conveyors 412 (Step 580) and/or may manually change the discharge rate of the fracturing pumps 200 (Step 582). When the operator takes control at Steps 580, 582, the operator may reactivate an automatic or scheduled program of the operation the controller 30 returns to monitoring the fluid pressure increase rate of Step 530.

The mitigation process 550 enables the controller 30 to automatically stop delivery of proppant to the fluid provided to the fracturing pumps 200 and to decrease the discharge rate of the fracturing pumps 200 until the fluid pressure increase rate is stabilized without input from an operator. During the mitigation process 550, including the process 560, an operator may be prevented or locked out from certain commands of the controller 30. For example, in some embodiments, during the mitigation process 550, an operator may be locked out of all commands to the controller 30 except at step 556 until the mitigation process 550 such that the fluid pressure increase rate has been stabilized. In certain embodiments, an operator may be locked out of increasing the discharge rate of the fracturing pumps 200 or initiating or increasing delivery of proppant during the mitigation process 550.

By reducing well screen out, the need for operations to reopen fractures or a well (e.g., wire line operations) may be reduced or eliminated such that time, and thus costs, to stimulate a well may be reduced. In addition, the method 500 of detecting and mitigating well screen out with a controller 30 may reduce rapid pressure increases associated with well screen outs such that stress on fracturing equipment may be reduced. The fracturing equipment may include, but not be limited to, fracturing pumps, power end assemblies of power units (e.g., gas turbine engines), gearboxes, transmissions, and piping or iron of the well site. Further, by intervening before the fluid supplied to the wellhead reaches the maximum fluid pressure, reliance on pressure relief valves, such as a wellhead pressure relief valve, may be reduced. Reducing reliance on pressure relief valves may conserve energy by not releasing pressure within the system and reduce stress on the fracturing equipment by maintaining a more consistent fluid pressure within the maximum wellhead pressure.

The method 500 being executed by the controller 30 allows for continuous monitoring of the fluid pressure and the fluid pressure increase rate at higher rate (e.g., 1 Hz to 300 Hz) when compared to relying on manual control and monitoring. In addition, by including multiple tiers of warnings (e.g., Tier 1 and Tier 2) the controller 30 alerts an operator to intervene before the fluid pressure approaches the maximum wellhead pressure and may automatically intervene if the fluid pressure increase rate reaches Tier 3 and the fluid pressure approaches the maximum wellhead pressure.

This is application is a continuation of U.S. Non-Provisional application Ser. No. 18/583,167, filed Feb. 21, 2024, titled “METHODS FOR DETECTION AND MITIGATION OF WELL SCREEN OUT,” which is a continuation of U.S. Non-Provisional application Ser. No. 17/991,007, filed Nov. 21, 2022, titled “METHODS FOR DETECTION AND MITIGATION OF WELL SCREEN OUT,” now U.S. Pat. No. 11,939,854 issued Mar. 26, 2024, which is a continuation of U.S. Non-Provisional application Ser. No. 17/355,920, filed Jun. 23, 2021, titled “METHODS FOR DETECTION AND MITIGATION OF WELL SCREEN OUT,” now U.S. Pat. No. 11,566,506 issued Jan. 31, 2023, which is continuation of U.S. Non-Provisional application Ser. No. 17/303,841, filed Jun. 9, 2021, titled “METHODS AND SYSTEMS FOR DETECTION AND MITIGATION OF WELL SCREEN OUT,” now U.S. Pat. No. 11,208,881, issued Dec. 28, 2021, which is a continuation of U.S. Non-Provisional application Ser. No. 17/182,408, filed Feb. 23, 2021, titled “METHODS FOR DETECTION AND MITIGATION OF WELL SCREEN OUT,” now U.S. Pat. No. 11,066,915, issued Jul. 20, 2021, which claims priority to and the benefit of U.S. Provisional Application No. 62/705,050, filed Jun. 9, 2020, titled “METHODS AND SYSTEMS FOR DETECTION AND MITIGATION OF WELL SCREEN OUT,” the disclosures of which are incorporated herein by reference in their entireties.

The foregoing description of the disclosure illustrates and describes various exemplary embodiments. Various additions, modifications, changes, etc., may be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

1. (canceled)

2. A wellsite hydraulic fracturing pumper system, the system comprising:
one or more fracturing pumps configured to pump fluid to a wellhead when positioned at a hydrocarbon well site;
one or more pressure transducers positioned at a location of one or more of: (a) adjacent an output of the one or more fracturing pumps, and (b) at the wellhead, the one or more pressure transducers each configured to measure a fluid pressure of the fluid provided to the wellhead; and
a controller to control the one or more fracturing pumps and positioned in signal communication with the one or more pressure transducers such that the controller receives the fluid pressure of the fluid provided to the wellhead, wherein the controller is configured to:
measure fluid pressure of the fluid supplied to the wellhead at a sampling rate;
determine a plurality of fluid pressure increase rates of the fluid supplied to the wellhead according to the sampling rate;
determine a smoothed fluid pressure increase rate by averaging at least two of the plurality of fluid pressure increase rates; and
comparing the smoothed fluid pressure increase rate to a predetermined increase rate; and
based on the smoothed fluid pressure increase rate exceeding the predetermined increase rate, incrementally decreasing a discharge rate of the one or more fracturing pumps to the wellhead.

3. The wellsite hydraulic fracturing pumper system according to claim 2, wherein the controller is configured to:
based on the smoothed fluid pressure increase rate exceeding the predetermined increase rate by a first amount, initiate an alert without automatically decreasing the discharge rate of the one or more fracturing pumps; and
based on the smoothed fluid pressure increase rate exceeding the predetermined increase rate by a second amount that is greater than the first amount, automatically incrementally decreasing the discharge rate of the one or more fracturing pumps.

4. The wellsite hydraulic fracturing pumper system according to claim 2, further comprising one or more blenders configured to provide fluid and proppant to the one or more fracturing pumps, wherein the controller is further in signal communication with the one or more blenders to control delivery of proppant to the one or more fracturing pumps.

5. The wellsite hydraulic fracturing pumper system according to claim 4, wherein based on the smoothed fluid pressure increase rate exceeding the predetermined increase rate, the controller is configured to:
compare the fluid pressure of the fluid provided to the wellhead to a first threshold; and
based on the fluid pressure being below the first threshold, maintaining the discharge rate of the one or more fracturing pumps and a flow rate of the one or more blender for a first period of time; and
based on the fluid pressure being exceeding the first threshold by a predetermined amount during the first period of time, incrementally decreasing the discharge rate of the one or more fracturing pumps and decreasing the flow rate of the one or more blender.

6. The wellsite hydraulic fracturing pumper system according to claim 2, wherein the sampling rate is selectable in a range of 1 Hz to 300 Hz.

7. The wellsite hydraulic fracturing pumper system according to claim 2, wherein when the smoothed fluid pressure increase rate exceeds the predetermined increase rate, setting the smoothed fluid pressure increase rate as a baseline rate.

8. The wellsite hydraulic fracturing pumper system according to claim 7, wherein incrementally decreasing the discharge rate of the one or more fracturing pumps includes:
decreasing the discharge rate by a first increment;
changing the sampling rate to a delayed sampling rate;
determining a delayed fluid pressure increase rate of the fluid supplied to the wellhead according to the delayed sampling rate;
comparing the delayed fluid pressure increase rate to the baseline rate; and
based on the delayed fluid pressure increase rate being greater than or equal to the baseline rate, decreasing the discharge rate by a second increment.

9. The wellsite hydraulic fracturing pumper system according to claim 2, wherein the controller is configured to prevent a single erroneous fluid pressure sample from triggering detection of a potential screen out.

10. A wellsite hydraulic fracturing pumper system, the system comprising:
one or more fracturing pumps configured to deliver fracturing fluid to a wellhead;
a blender configured to deliver fluid and proppant to the one or more fracturing pumps;
at least one pressure transducer disposed at a surface location selected from: adjacent an outlet of the one or more fracturing pumps, within a manifold in fluid communication with the wellhead, or at the wellhead, the at least one pressure transducer generating pressure samples of the fracturing fluid; and
a controller in signal communication with the at least one pressure transducer, the blender, and the one or more fracturing pumps, the controller comprising a memory storing a program and a processor executing the program to:
sample a pressure of the fracturing fluid at a sampling rate to obtain successive pressure samples;
compute, from the successive pressure samples, a plurality of pressure rate-of-change values and
calculate a smoothed pressure increase rate by averaging a plurality of the pressure rate-of-change values over a configurable window;
compare the smoothed pressure increase rate to a programmable rise threshold;
when the smoothed pressure increase rate exceeds the programmable rise threshold for a persistence duration spanning multiple windows enter a mitigation mode in which the controller:
(i) prevents an operator from increasing a discharge rate of the one or more fracturing pumps, and
(ii) issues sequenced control signals that first decrease the discharge rate of the one or more fracturing pumps by an increment and then decrease a flow rate of the blender; and
repeat the sequenced decreases until the smoothed pressure increase rate is non-positive.

11. The wellsite hydraulic fracturing pumper system according to claim 10, wherein when the the smoothed pressure increase rate is non-positive, the controller is configured to terminate the mitigation mode.

12. The wellsite hydraulic fracturing pumper system according to claim 10, wherein the sampling rate is selectable in a range of 1 Hz to 300 Hz.

13. The wellsite hydraulic fracturing pumper system according to claim 10, wherein the configurable window comprises an average of between 2 and 100 pressure rate-of-change values.

14. The wellsite hydraulic fracturing pumper system according to claim 10, wherein the controller is further configured to generate tiered alerts prior to entry into the mitigation mode for different bands of the smoothed pressure increase rate.

15. The wellsite hydraulic fracturing pumper system according to claim 10, wherein the increment is selected based on a magnitude of the smoothed pressure increase rate.

16. The wellsite hydraulic fracturing pumper system according to claim 10, further comprising a plurality of pressure transducers, and wherein the controller computes the pressure samples as an average of measurements from outputs of a plurality of the fracturing pumps.

17. The wellsite hydraulic fracturing pumper system according to claim 10, wherein the controller is further configured, in the mitigation mode, to stop delivery of proppant deactivating a screw conveyor of the blender when proppant is being added.

18. The wellsite hydraulic fracturing pumper system according to claim 10, wherein decreasing the flow rate of the blender includes decreasing a flow rate of a discharge pump of the blender.

19. A wellsite hydraulic fracturing pumper system, the system comprising:
one or more fracturing pumps configured to deliver fracturing fluid to a wellhead;
at least one pressure transducer disposed at a surface location selected from: adjacent an outlet of one or more fracturing pumps, within a manifold in fluid communication with a wellhead, or at the wellhead, the at least one pressure transducer generating pressure samples of fracturing fluid; and
a controller in signal communication with the at least one pressure transducer, the controller configured to:
sample a pressure of fracturing fluid at a first sampling rate to obtain successive pressure samples;
compute, from the successive pressure samples, a plurality of fluid pressure increase rates; and
calculate a smoothed pressure increase rate by averaging a first subset of the plurality of fluid pressure increase rates over a first period of time;
compare the smoothed pressure increase rate to a plurality of increase thresholds;
when the smoothed pressure increase rate exceeds a first increase threshold of the plurality of increase thresholds, initiate a first alert and maintain a discharge rate of the one or more fracturing pumps;
when the smoothed pressure increase rate exceeds a second increase threshold of the plurality of increase thresholds, initiate a mitigation protocol program in which the controller:
decreases the discharge rate of the one or more fracturing pumps by a first increment;
samples the pressure of fracturing fluid at a delayed sampling rate to obtain delayed pressure samples of the fracturing fluid;
compute, from the delayed pressure samples, a mitigated fluid pressure increase rate;
compare the mitigated fluid pressure increase rate to a baseline rate that is greater than or equal to the second increase threshold;
repeat the incremental decreases of the discharge rate until the mitigated fluid pressure increase rate is less than the baseline rate.

20. The wellsite hydraulic fracturing pumper system according to claim 19, wherein:
when the smoothed pressure increase rate exceeds a third increase threshold of the plurality of increase thresholds, the controller is configured to initiate a second alert and maintain a discharge rate of the one or more fracturing pumps; and
the third increase threshold is greater than the first increase threshold and less than the second increase threshold.

21. The wellsite hydraulic fracturing pumper system according to claim 19, wherein the delayed sampling rate includes:
sampling the pressure of fracturing fluid at a second sampling rate that is greater than the first sampling rate; or
delaying the first sampling rate by a predetermined period of time.
